(19) United States
(12) Patent Application Publication
(10) Pub. No.: US 2008/0085146 A1
(43) Pub. Date: Apr. 10, 2008

(54) GIFT ORGANIZER

(76) Inventor: Amy Botkin, Dayton, OH (US)

Correspondence Address: MEADWESTVACO CORPORATION, 1021 MAIN CAMPUS DRIVE, CENTENNIAL CAMPUS, RALEIGH, NC, 27606, US

(21) Appl. No.: 11/857,031

(22) Filed: Sep. 18, 2007

Related U.S. Application Data
(60) Provisional application No. 60/845,641, filed on Sep. 19, 2006.

(51) Int. Cl. B42F 3/00; B42D 1/00; B42F 13/00

(52) U.S. Cl. 402/70; 281/21.1; 281/38; 402/73

(57) ABSTRACT

A gift organizer for storing various gift information includes a pair of front and rear covers and two or more sets of pages bound together to the front and rear covers. The sets of pages are provided respectively with pre-printed category indicators each specific to the respective set of pages to designate the respective set of pages for storing gift information of a specific category.

### CROSS-REFERENCE TO RELATED APPLICATION

This application claims the benefit of the filing date of U.S. Provisional Application Ser. No. 60/845,641, entitled “Gift Organizer” filed on Sep. 19, 2006, the entirety of which is incorporated herein by reference.

### BACKGROUND

The present invention is directed to an organizer, and more particularly, to an organizer for storing various information relating to gift giving.

Gift giving is a popular and a widespread activity practiced at major holidays (such as Christmas, Valentine's Day, Father's Day, Mother's Day, etc.), birthdays, anniversaries, graduations, retirements, weddings, baby and wedding showers, and the like. Due to the year-long attention which must be paid to such events, as well as the numerous individuals, dates and other information which must be tracked, there is a need for an organizer which can store such information in a central location.

### SUMMARY OF THE INVENTION

The disclosure in a first aspect provides a gift organizer for storing various gift information in a single component. The gift organizer comprises a pair of front and rear covers and two or more sets of pages bound together to the front and rear covers such that the sets of pages are disposed between the front and rear covers. The sets of pages are provided respectively with different pre-printed category indicators each specific to the respective set of pages to designate the respective set of pages for storing gift information of a specific category.

In a preferred embodiment of the first aspect, the gift organizer may further comprise tabs associated with the sets of pages respectively. The tabs may be fixed to the gift organizer such that each tab extends outwardly from the outer perimeter of the sets of pages to provide a protruding surface. The pre-printed category indicators may be printed on the protruding surfaces of the tabs respectively. In this embodiment, the gift organizer may further comprise divider sheets bound together with and placed among the sets of pages such that each divider sheet is followed by the respective set of pages. The tabs may be carried by the divider sheets respectively. Alternatively, each tab may be coupled to one of the pages of the respective set. While having the tabs with the first pre-printed category indicators, the gift organizer may further comprise second pre-printed category indicators associated with the sets of pages respectively. Each second pre-printed category indicator may be printed on at least one of the pages of the respective set. The second pre-printed category indicator associated with each set of pages may be substantially identical to the first preprinted category indicator on the tab associated with that set of pages.

In another embodiment, each pre-printed category indicator may be printed on at least one of the pages of the respective set. Each pre-printed category indicator may be printed on each page of the respective set. Each page the respective set may also include at least one lined area to provide a space for placing gift information on it.

In still another embodiment, the gift organizer may further comprise a closure mechanism for coupling the front and rear covers to keep the gift organizer in a closed position. The closure mechanism may comprise a strap coupled to the front cover by an attachment tab wherein the strap may be formed of elastic material so that the strap is stretchable to fit around the front and rear covers.

In a further embodiment, the gift organizer may further comprise a binding arrangement for binding the set of pages and the front and rear covers.

In a further embodiment, the gift organizer may further comprise an envelope bound to the organizer for storing loose items associated with gifts.

In a further embodiment, at least one of the pre-printed category indicators may be a date indicia for designating the respective set of pages for storing specific dates associated with gifts.

In a further embodiment, at least one of the pre-printed category indicators may be an idea indicia for designating the respective set of pages for storing gift ideas.

In a further embodiment, at least one of the pre-printed category indicators may be a given gift indicia for designating the respective set of pages for storing information of gifts that were given by a user.

In a further embodiment, at least one of the pre-printed category indicators may be a received gift indicia for designating the respective set of pages for storing information of gifts received by a user.

In a further embodiment, at least one of the pre-printed category indicators may be a contact indicia for designating the respective set of pages for storing contact information for various individuals.

The present disclosure in a second aspect provides a bound component for organizing gift information. The bound component comprises first and second sets of pages bound together. The first and second sets of pages are provided respectively with pre-printed category indicators each specific to the respective set of pages. The pre-printed category indicator for the first set of pages comprises a date indicia for designating the first set of pages for storing specific dates associated with gifts while the pre-printed category indicator for the second set of pages comprises a given gift indicia for designating the second set of pages for storing information of gifts that were given by a user.

In one embodiment of the second aspect, the bound component may further comprise a third set of pages provided with a pre-printed category indicator specific to the third set of pages. The pre-printed category indicator for the third set of pages may be a received gift indicia for designating the third set of pages for storing information of gifts received by a user. Alternatively, the pre-printed category indicator for the third set of pages may be a contact indicia for designating the third set of pages for storing contact information for various individuals. Alternatively, the pre-printed category indicator for the third set of pages may be an idea indicia for designating the third set of pages for storing gift ideas.

### BRIEF DESCRIPTION OF THE DRAWINGS

FIG. 1 is a top perspective view of one embodiment of the organizer of the present invention, shown in a closed position;

FIG. 2 is a top view of the organizer of FIG. 1, with the front cover moved to an open position to expose the front side of the top divider;

FIG. 3 is a top view of the organizer of FIG. 2, with the top divider pivoted about the binding mechanism to expose the front side of the first page;

FIG. 4 is a front perspective view of the organizer of FIG. 3; and

FIG. 5 is a top view of the organizer of FIG. 2, with all of the pages pivoted about the binding mechanism to expose the front side of the rear cover.

### DETAILED DESCRIPTION

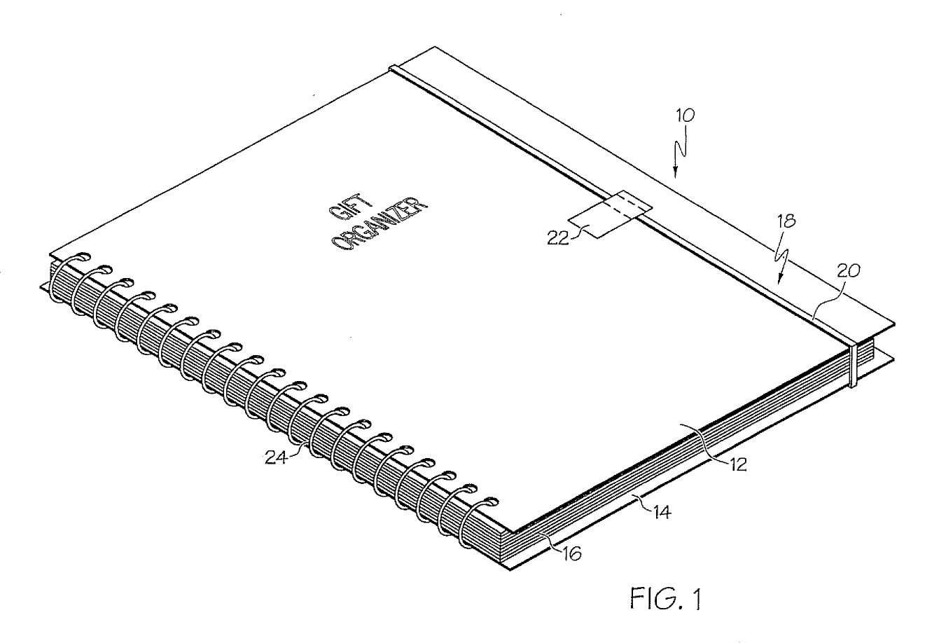

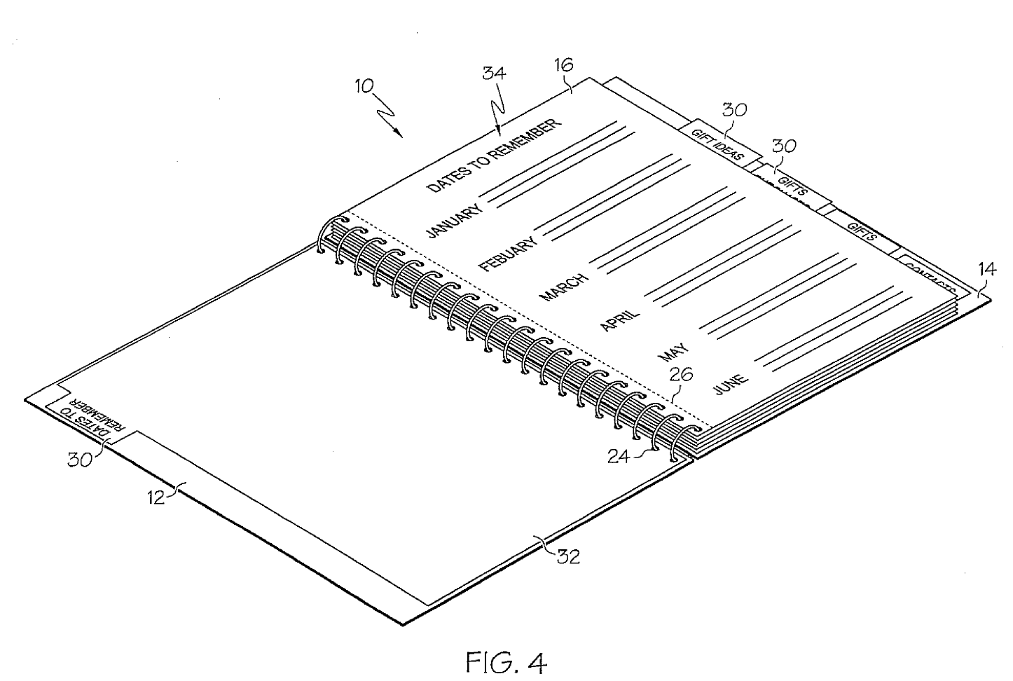

As shown in FIGS. 1-5, in one embodiment the organizer 10 of the present invention is in the form of a bound component, such as a book, notebook, notepad, organizer, journal or the like. In the illustrated embodiment the organizer 10 includes a front cover 12 and a rear 14 cover with a plurality of pages, sheets or papers 16 (together termed “pages” herein) bound therebetween. Each of the pages 16 may be made of a cellulose-based paper, or other generally water absorbent material, such that the pages 16 can be written on by a wide variety of media, such as pens, pencils, markers or the like. Each of the covers 12, 14 may be of a relatively stiff and/or rigid material, such as cardboard, paperboard or the like, or which is made of a material stiffer and/or more rigid than each of the pages 16.

A closure mechanism 18 may be utilized to couple the front 12 and rear 14 covers and keep the organizer 10 in a closed position. In the illustrated embodiment, the closure mechanism 18 takes the form of an elastic strap 20 coupled to the front cover 12 by an attachment tab 22, wherein the strap 20 can be stretched to fit around the front 12 and rear 14 covers. If desired, a spine (not shown) may be positioned between the front 12 and rear 14 covers and bound to the pages 16 such that each cover 12, 14 is pivotally coupled to the spine, although the illustrated embodiment does not utilize a spine.

In the embodiment shown in FIGS. 1-5, the pages 16 and cover 12, 14 are bound together by a single coil wire binding arrangement 24. However, the covers 12, 14 and pages 16 can be bound together by any of a wide variety of binding arrangements, such as spiral or coil binding wires, twin wire coils, adhesive-style bindings, various clips, prongs, staples, book-style binding, or the like.

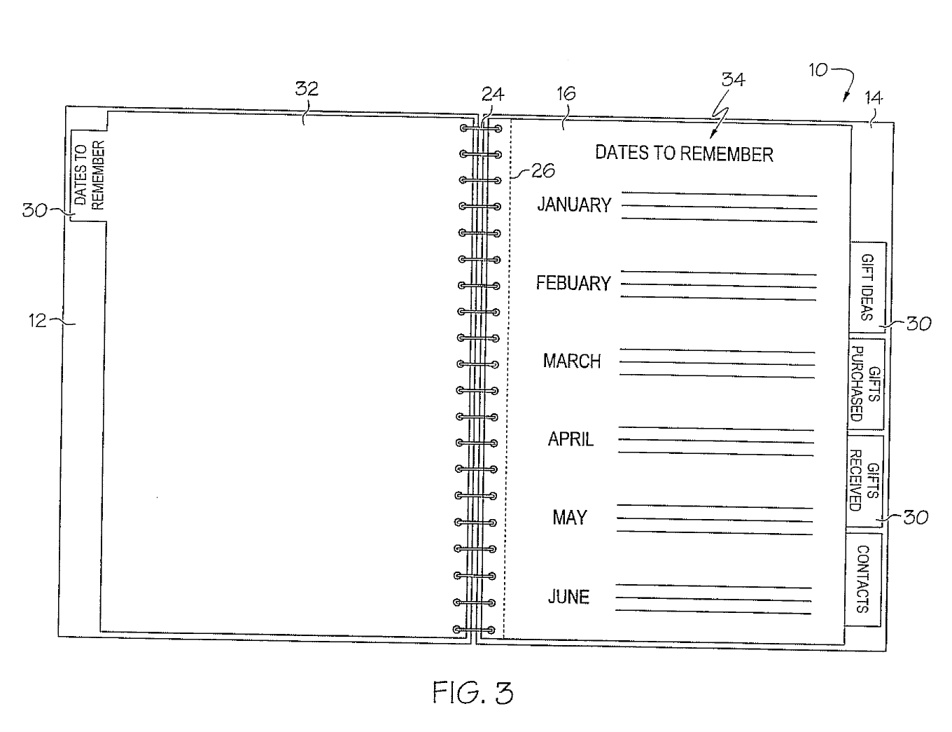

As best shown in FIG. 3, each of the pages 16 may be a generally rectangular sheet and may have a variety of widths, such as between about 3 inches and about 8½ inches, and can have a variety of heights, such as between about 5 inches and about 11 inches. Each of the covers 12, 14 may have a height and width slightly greater than each of the pages 16 to protect the pages 16 bound therein. Each sheet 16 may have a severance line such as a perforation line 26 (FIG. 3) extending along its binding edge to allow the respective sheet 16 to be torn along the perforation line 26 and separated from the organizer 10. However, the perforation line 26 may be omitted.

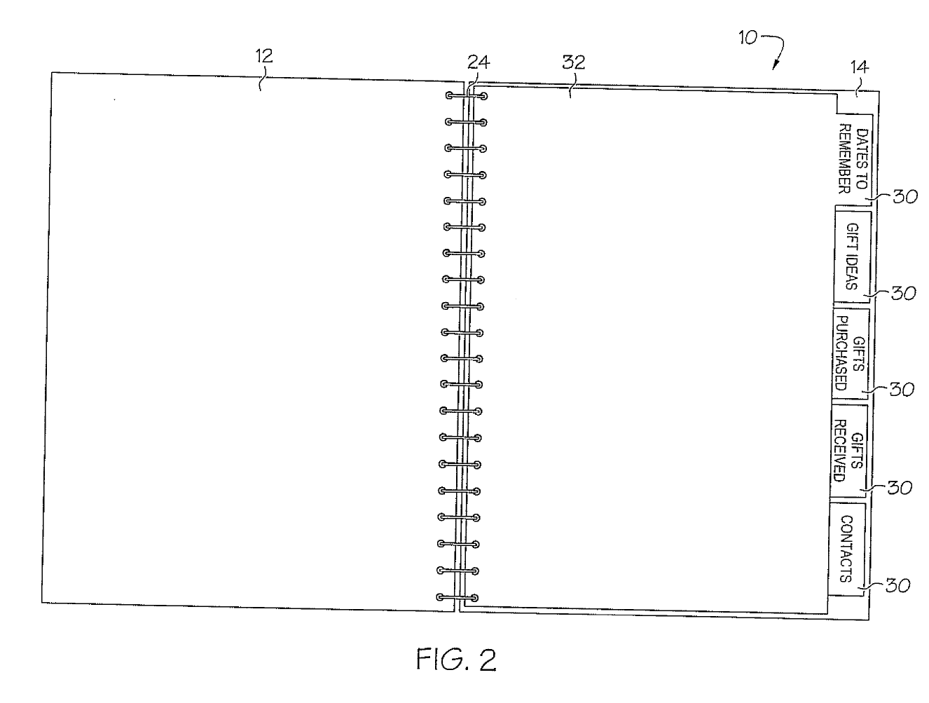

As can be seen in FIGS. 2-5, the organizer 10 may include a plurality of tabs 30 spaced throughout the thickness of the organizer 10. Each tab 30 may be coupled to, or formed as a part of, a tab sheet 32 or divider which itself is bound into the binding arrangement 24 (see FIG. 2). Alternately, each tab 30 can be directly coupled to one of the pages 16. Each tab 30 extends outwardly from an outer perimeter of the stack of pages 16 such that the tab 30 provides a protruding surface which can be easily viewed. The tabs 30 may divide the organizer 10 into various categories of pages 16, as will be described in greater detail below.

The set of pages 16 associated with each tab 30 may each include pre-printed information or indicia 34 that is the same as, or conveys the same information as, the information or indicia on the associated tab 30, as can be seen by comparing FIGS. 2 and 3. For example, if the tab 30 has the text “Dates to Remember” printed thereon, each associated or underlying page 16 may have the text “Dates to Remember” printed as a header. Each page 16 may be lined or include lined areas to provide a space for the user to print, write, draw, stick, stamp or place information thereon.

As shown in FIG. 2, the organizer may include a tab 30 and/or associated pages labeled “Dates to Remember” or the like which allows the user to store, in a single location, specific dates associated with individuals or individual events (i.e., birthdays, anniversaries, graduations, retirements, weddings, baby and wedding showers, etc.) to remind the user of such dates. Another tab 30 and/or associated pages 16 may be labeled “Gift Ideas” or the like which allows the user to write down ideas for gift giving and/or receiving. More particularly, this feature allows a user to store gift ideas in a single location as the user identifies gift ideas which may be noted at a time that is distant in time from the gift giving event.

Another tab 30 and/or associated pages 16 may be labeled “Gifts Purchased,” “Gifts Given” or the like to allow the user to track gifts given by the user to various individuals. This feature may be useful to the user to ensure that the same gift is not again given to an individual at a later time, and to track the expense of previous gifts given, etc. The user can also track the recipient's (favorable or unfavorable) reaction to a gift, for example, to gauge whether other similar gifts should be pursued or avoided. Another tab 30 and/or associated pages 16 may be labeled “Gifts Received” or the like such that the user can list gifts received by the user. This feature may be useful to identify gifts received from any particular individual to determine the type of gifts the user may wish to give, in turn, to that individual (i.e., types of gifts, typical expense, etc.).

Another tab 30 and/or associated pages 16 may be labeled “Contacts,” “Contact Information” or the like to allow the user to store names, addresses, email addresses, telephone numbers, etc. for various individuals. Such information can be utilized when, for example, shipping gifts or the like.

Another tab 30 and/or associated pages 16 (not shown) may be labeled “Suggested Gifts” or the like. The associated pages may contain a pre-printed list of various gift ideas to suggest various gift ideas should the user have difficulty in identifying a gift for a particular individual. The organizer 10 may include another tab 30 and/or associated pages 16 (not shown) labeled “Holidays” or the like to provide a list of pre-printed religious and secular holiday dates, which reminds the user of potential upcoming gift giving events. An “Owner Information” tab 30 and/or pages 16 (not shown) may also be provided, such as at the front or rear of the organizer 10, to allow the owner/user to place his or her contact information to allow the organizer 10 to be returned to the user should the organizer 10 become misplaced or lost. Of course, the labels on the tabs 30 and/or the associated pages 16 can be varied from that shown and described herein, and any of a variety of text, symbols, drawings, indicia or the like may be used.

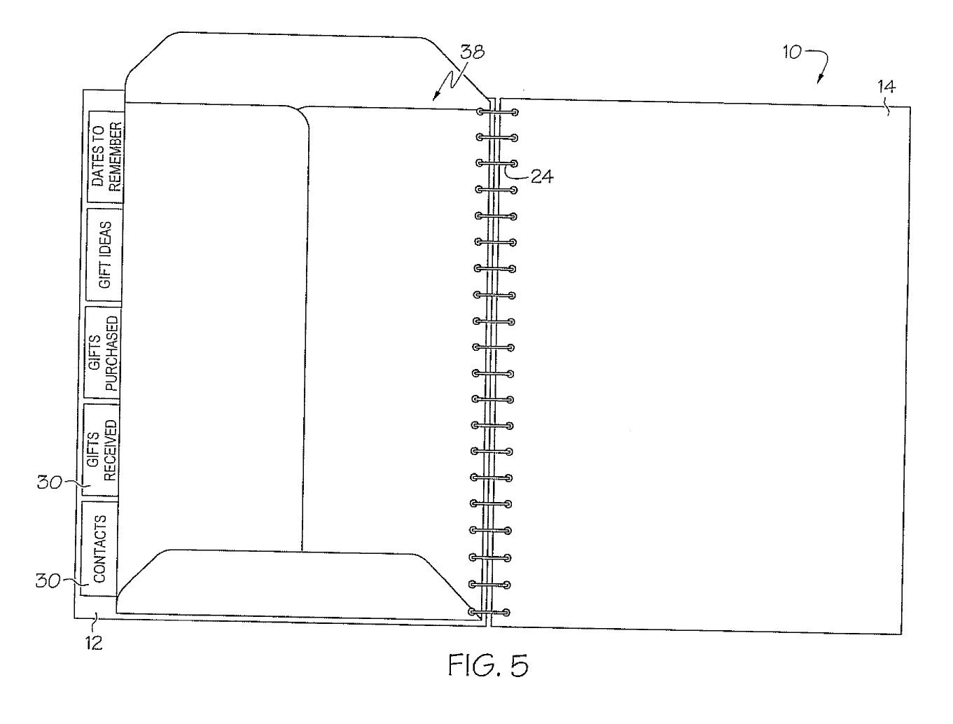

As shown in FIG. 5, a pocket envelope or the like 38 may be bound to the organizer 10 or located on one of the covers 12, 14, dividers 32 or pages 16, to allow the user to store receipts for gifts given or gifts received therein, or to store other loose items such as a gift registry print-out or invitations. If desired, a pocket may also be positioned on the front 12 and/or rear 14 covers.

In one embodiment the present invention is an organizer which stores various gift information for various gift-giving or gift-receiving events in a single component. More particularly, in one embodiment the invention is a gift organizer including a plurality of bound pages, and including indicia that suggests a user to write, on the pages, information relating to gift-giving ideas for individuals and dates associated giving gifts to the individuals. In another embodiment the invention is a method for storing information, including the steps of providing an organizer having a plurality of pages, and writing, on the pages, information relating to gift-giving ideas for individual and dates associated with giving gifts to the individuals.

Having described the invention in detail and by reference to the preferred embodiments, it will be apparent that modifications and variations thereof are possible without departing from the scope of the invention.

What is claimed is:

1. A gift organizer for storing various gift information in a single component, the gift organizer comprising a pair of front and rear covers, and two or more sets of pages bound together to the front and rear covers such that the sets of pages are disposed between the front and rear covers, the sets of pages being provided respectively with first pre-printed category indicators each specific to a respective one of the sets of pages to designate the respective one of the sets of pages for storing gift information of a specific category.

2. The gift organizer of claim 1 further comprising tabs associated with the sets of pages respectively, wherein the tabs are fixed to the gift organizer such that each of the tabs extends outwardly from an outer perimeter of the sets of pages to provide a protruding surface, and wherein the pre-printed category indicators are printed on the protruding surfaces of the tabs respectively.

3. The gift organizer of claim 2 further comprising divider sheets bound together with and placed among the sets of pages such that each of the divider sheets is followed by a respective one of the sets of pages, wherein the tabs are carried by the divider sheets respectively.

4. The gift organizer of claim 2 wherein each of the tabs is coupled to one of the pages of the respective set.

5. The gift organizer of claim 1 wherein each of the pre-printed category indicators is printed on at least one of the pages of the respective set.

6. The gift organizer of claim 5 wherein each of the pre-printed category indicators is printed on each of the pages of the respective set.

7. The gift organizer of claim 6 wherein the each of the pages the respective set includes at least one lined area to provide a space for placing gift information thereon.

8. The gift organizer of claim 2 further comprising second pre-printed category indicators associated with the sets of pages respectively such that each of the second pre-printed category indicators is printed on at least one of the pages of the respective set, the second pre-printed category indicator associated with each set of pages is substantially identical to the first preprinted category indicator on the tab associated with the each set of pages.

9. The gift organizer of claim 1 further comprising a closure mechanism for coupling the front and rear covers to keep the gift organizer in a closed position.

10. The gift organizer of claim 9 wherein the closure mechanism comprises a strap coupled to the front cover by an attachment tab wherein the strap is formed of elastic material so that the strap is stretchable to fit around the front and rear covers.

11. The gift organizer of claim 1 further comprising a binding arrangement for binding the set of pages and the front and rear covers.

12. The gift organizer of claim 1 further comprising an envelope bound to the organizer for storing loose items associated with gifts.

13. The gift organizer of claim 1 wherein at least one of the pre-printed category indicators comprises a date indicia for designating a respective one of the sets of pages for storing specific dates associated with gifts.

14. The gift organizer of claim 1 wherein at least one of the pre-printed category indicators comprises an idea indicia for designating a respective one of the sets of pages for storing gift ideas.

15. The gift organizer of claim 1 wherein at least one of the pre-printed category indicators comprises a given gift indicia for designating a respective one of the sets of pages for storing information of gifts that were given by a user.

16. The gift organizer of claim 1 wherein at least one of the pre-printed category indicators comprises a received gift indicia for designating a respective one of the sets of pages for storing information of gifts received by a user.

17. The gift organizer of claim 1 wherein at least one of the pre-printed category indicators comprises a contact indicia for designating a respective one of the sets of pages for storing contact information for various individuals.

18. A bound component for organizing gift information, the bound component comprising first and second sets of pages bound together, the first and second sets of pages being provided respectively with pre-printed category indicators each specific to a respective one of the first and second sets of pages, wherein the pre-printed category indicator for the first set of pages comprises a date indicia for designating the first set of pages for storing specific dates associated with gifts and the pre-printed category indicator for the second set of pages comprises a given gift indicia for designating the second set of pages for storing information of gifts that were given by a user.

19. The bound component of claim 18 further comprising a third set of pages provided with a pre-printed category indicator specific to the third set of pages wherein the pre-printed category indicator for the third set of pages comprises a received gift indicia for designating the third set of pages for storing information of gifts received by a user.

20. The bound component of claim 18 further comprising a third set of pages provided with a pre-printed category indicator specific to the third set of pages wherein the pre-printed category indicator for the third set of pages comprises a contact indicia for designating the third set of pages for storing contact information for various individuals.

21. The bound component of claim 18 further comprising a third set of pages provided with a pre-printed category indicator specific to the third set of pages wherein the pre-printed category indicator for the third set of pages comprises an idea indicia for designating the third set of pages for storing gift ideas.
